(19) United States
(12) Patent Application Publication
(10) Pub. No.: US 2011/0120388 A1
(43) Pub. Date: May 26, 2011

(54) Illuminated/multi-faceted pet leash assembly

(76) Inventor: Manouch Shahbaz, Houston, TX (US)

(21) Appl. No.: 12/591,641

(22) Filed: Nov. 25, 2009

(51) Int. Cl. A01K 27/00

(52) U.S. Cl. 119/796

(57) ABSTRACT

A multi-purpose customizable, protective and retractable dog leash combining the following integral features into a single lightweight hand-held item: 1) a retractable luminescent fiber optic filament in the leash material to aid in illumination and visibility providing a higher margin of safety for pets and their owners while walking in dimly lit environments where vehicles are encountered; 2) a rechargeable nano beam flash light component that provides additional illumination and further alert to oncoming traffic to the presence of the user; 3) a pepper spray component that the user can operate for additional safety in the event of a attack/assault and as a potential deterrent; and 4) an alarm/panic horn component that the user can operate for additional safety in the event of a attack/assault and as a potential deterrent.

### RELATED APPLICATION

This application claims priority of co-pending U.S. provisional application Ser. No. 61/033,520 filed on Mar. 4, 2008.

### BACKGROUND OF THE INVENTION

1. Field of the Invention

The present invention relates generally to the field of leashes for pets. More specifically, this invention relates to devices used to restrain and control an animal's freedom of movement and distance from its owner or trainer, with a hand held restraint and a retractable leash cord mechanism with additional features providing extra safety to the user as described below.

2. Description of the Related Art

There have long been leashes for controlling and holding pets during walks. Devices for restraining, controlling and limiting the distance a pet or animal can wander from a tethered point or person are well known in the art. Typically these devices are unsafe and mechanically unreliable or difficult to operate with one hand. One problem associated with such devices is that leashes occupy at least one hand of a user so that other items, which can be useful or necessary to the user, cannot easily be carried. Some safety items, such as a flashlight and defensive items such as a pepper spray component, alarm or taser may therefore be left behind. One may stray into an unfamiliar area with poor lighting while walking a pet. One may be more vulnerable to crime while out walking a pet, because one is typically outside his or her yard and on foot in a public place. Therefore, it is while one is walking a pet that certain items are apt to be most urgently needed and yet not at hand.

There is no example of any unit combining all of the features included in this item. An example of a combined pet leash and flashlight is disclosed in U.S. Pat. No. 5,429,075 issued to Passarella et al. on Jul. 4, 1995. The Passarella device is a conventional pet leash having the handle portion (42) secured to a conventional flashlight. There is no provision in Passarella for a retractable leash or a restraining mechanism for controlling a leash that is also a flashlight. The Passarella device merely provides a means for keeping a conventional leash and a conventional flashlight joined together. An example of a combined pet leash and radio is disclosed in U.S. Pat. No. 5,887,550 issued to Levine, et al on Mar. 30, 1999. However, there is no provision in Levine for pepper spray, alarm or taser component being present in the leash unit.

Therefore, there exists a need for a device that is a combination retractable pet leash, flashlight, pepper spray, alarm and taser having a restraining mechanism for controlling a leash with a rechargeable battery for all of the accompanying components, in which the combined device can be held and controlled in one hand in which the various switches and stopping mechanism can be operated with one finger of the hand holding the device.

### SUMMARY OF THE INVENTION

The present invention is an improved combined pet leash, flashlight, pepper spray, alarm and taser comprising a mechanical dispensing and retracting cord for the purpose of tethering, restraining and controlling a pet during a walk. The present invention includes a variety of features which are set forth in detail below.

1. Combination Flashlight

The present invention comprises a built in flashlight that is operated by the user. The incorporation of the flashlight removes the need for the pedestrian to carry a separate flashlight in the opposite hand for the purposes of illuminating the walking path or site and to alert others to the presence of the user and pet. By encompassing both a retractable pet leash mechanism and a flashlight, the user is permitted a greater degree of safety and higher visibility of the pet, the user, and/or any feces left by the pet, which the owner may be responsible for. If a person is using both hands, one for the flashlight and the other to hold the leash, the user cannot take close control of the pet's collar (which is the standard and best means of controlling a pet in an emergency situation), unless the user drops the flashlight, and thus compromising safety and means of clear sight and high visibility. The light bulb reflector in the device of the present invention provides optimum and even beam spreading at a range of 1 to 16 feet, for example. Most flashlights use a polished parabolic reflector that leave bright spots making it difficult to see easily between the bright spots and dark areas directly adjacent to the bright spots. The lenticulated surface of the reflector of the present invention provides a smooth beam of light that is sufficiently even to permit the user to read a newspaper if so desired.

The light source of the pet leash assembly of the present invention in one embodiment is angled upward 20 to 30 degrees to the horizontal axis of the housing to reduce wrist fatigue to the user. The most comfortable position of use of the pet leash assembly of the present invention would be to point the unit directly to the ground at the user's feet. By angling the light source at an upward angle of 20 to 30 degrees off the horizontal axis of the housing, the fatigue on the user's wrist is reduced by not having to hold the wrist in such a manner necessary to illuminate the path three to fifteen feet ahead.

2. Locking Mechanism Feature

A second feature of the present invention is the one finger stop and lock mechanism. Existing products on the market use one of a few techniques to pause or stop and lock the further reeling out, or retracting of the leash cord. There are at least two control options on existing retractable dog leashes. When the buttons on the retractable leashes of the past were depressed, with a constant finger pressure, the buttons would engage a stop to prevent any further cord from reeling out. When finger pressure on the button was released, the cord was then free to reel in and out to any length desired.

The second option available on the prior devices was a lock and/or hold position. The difference between these two types of stops is similar to the pause versus stop button on mechanical audio cassette tape deck. In the pause mode, constant finger pressure is usually applied to the button to temporarily stop letting out, or reeling in of any leash cord. The stop/lock mode and the reel were locked into position by an intruding or engaging piece of metal or plastic that prevents the reel from moving, without the need for constant finger pressure.

In the past, pet leashes included a locking mechanism in which the leash lock button was fully engaged with one finger movement such that the reel would be locked into place and the finger could be removed. To disengage the lock, the reverse movement would have to be performed. There was no option for a temporary pause position, it was either locked at a fixed length or unlocked.

Prior pet leashes also included a pause/hold button (or lever) that was pushed by one finger to stop the reel from letting out any more leash cord. Then another finger was required to push a second pin/button or lever, that was perpendicular to the first button, and on the side of the housing, into the housing to lock the reel in place such that finger pressure would then be released from the first button. Such a device required two hands to operate both buttons and lock the mechanism. The second pin/button that was used on such a design, jammed, jams often, got filled with dirt and became difficult to engage without excess finger pressure or resulted in contortions of the hand to reach it with the same hand holding the leash. Therefore, a second hand was required (the one holding the flashlight) to push in the lock button.

In the present invention, a one point engagement/locking mechanism is disclosed which is more reliable than the prior device because only one mechanism has to align and interface with the reel mechanism to either pause/stop or lock the device. The slot of the present invention used to lock the button is self-cleaning and not easily affected by environmental contaminates.

The advantages of the present invention are that many features (including the light, stop and lock mechanisms), are incorporated into a one handed, one finger operation. The stop and lock mechanisms use less finger pressure and exertion to engage and disengage and provides both the option of a momentary hold on the leash to allow it to be dispensed at a controlled rate, and/or stop and lock the fixed cord at the length dispensed.

In the stop/lock mode of the present invention, finger pressure is applied momentarily to slide the pause button into the engaged locked position. After initial finger pressure is applied, the mechanism and leash length is locked in place, and cannot be changed without reversing the process. Both pause and locked button positions are engaged by use of only one finger, typically the user's thumb. In the present invention, no second hand or finger is needed to operate the light and stop and lock mechanisms or any other feature the present invention.

3. A Luminescent Fiber Optic Filament in the Leash

Another feature of the present invention is the inclusion of a luminescent fiber optic filament in the leash cord itself. This features provides for illumination of the leash cord thereby allowing the individual holding the Lease Assembly to be seen by passersby as well as vehicles. The advantage of this component is additional visibility thereby providing the user additional safety.

4. Special Features of the Rechargeable Version of the Present Invention

On most rechargeable devices, the batteries are either recharged (1) by removing the batteries and placing them in a charger, (2) bringing a power cord and plug up to and into the device, or (3) the device will have power contacts on the outer housing so it charges when placed in the cradle which only allows factory servicing for battery replacement.

In the present invention, the recharging contacts are on the battery door (and or housing), for easy charging of the batteries while the unit is in its cradle, or for easily removing the batteries to charge them in a separate unit. Also, the batteries of the device of the present invention may be easily changed by the consumer. None of the prior devices has a removable battery and combined cradle recharged devices.

A removable or permanently attached hand strap allows the user to maintain control and possession of the device of the present invention in that the device can hang from the wrist or from a pole/stake to remove the tiresome task of actually having to constantly hold the device to temporarily allow two hands to be free for performing other tasks, such as grasping the pet with both hands in an emergency situation, or to allow unattended use of the device by the pet. For example, while the pet is tied to a bench, and the owner is away from the pet.

5. Additional Features

This device also includes other components, all intended to provide additional safety to the user, which are not present on other leash assemblies. Specifically, this unit includes pepper spray and audible alarm components, all of which operate off of the rechargeable battery.

### OBJECTS OF THE PRESENT INVENTION

It is thus an object of the present invention to provide a leash apparatus which combines the pet control means of a leash with means for retaining items particularly needed when walking a pet. It is another object of the present invention to provide such an apparatus which specifically also includes flashlight, pepper spray and alarm components built into the housing unit of the leash.

It is still another object of the present invention to provide such an apparatus which provides fast and easy access to these items for maximized safety and convenience.

It is finally an object of the present invention to provide such an apparatus which is simple and reliable in construction and inexpensive to manufacture.

These and other objects of the present invention will become apparent from a review of the accompanying drawings and the detailed description of the drawings.

### BRIEF DESCRIPTION OF THE DRAWINGS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

FIG. 1 illustrates an embodiment of the basic Leash Assembly with a plastic case that surrounds the internal mechanisms, a clasp hook for attaching the leash to the collar of an animal, and a grip handle that is advantageously configured, when the leash is completely retracted, to mate with and approximately conform to the shape of the case. FIG. 1 also illustrates the inclusion and location of several of the components including the nano beam light, the panic siren, panic button, rechargeable battery input jack, panic lights, nano beam flashlight, the fiber optic rope, the light switch button and the optional fiber optic battery powered light source.

Although various sizes of the leash are possible, the version of the Leash Assembly involved herein provides for a length of 16 feet.

FIG. 2 illustrates a cutaway side view of the mechanism indicating the internal locations and inner workings of the various components to include the location of the battery, battery access door, pepper spray lid, circuit board for the panic alarm and leash control buttons. The leash is wound around a leash spool that is affixed to the case via a spool spindle around which the spool can rotate. A leash control button is designed to move forward and come into position on the leash spool at predetermined intervals thereby affecting the length of leash that is protruding from the unit assembly. Unlocking the leash control button by pushing on it allows the leash to recoil back into the unit assembly.

FIG. 3 illustrates front and rear views of the Leash Assembly indicating the locations of the various components.

FIG. 4 illustrates a ¾ exploded view of the Leash Assembly once again indicating the locations of the various components to include the location of the battery which can either be a 9 volt or flat type of battery, both rechargeable through the housing of the Leash Assembly. FIG. 4 also indicates the location of the pepper spray canister and the thumb release latch for the area housing the canister.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

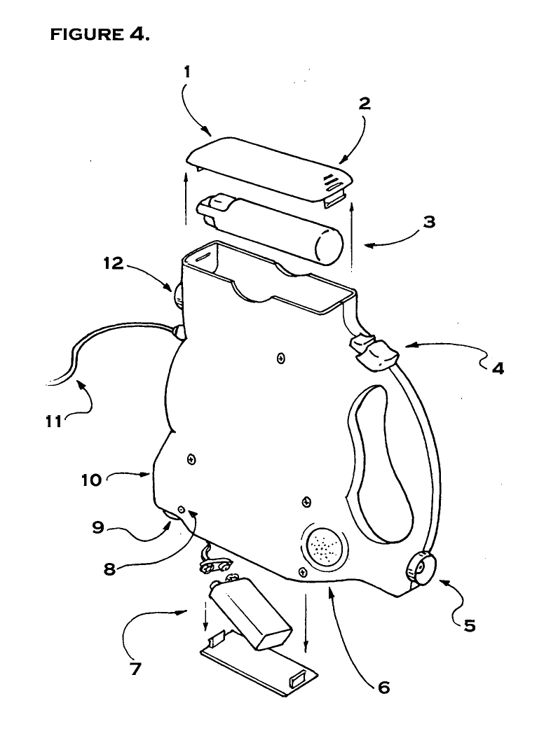

### Retractable Leash (¾ Exploded View) FIG. 4

1 Pepper Spray Cap
2 Thumb Release Latch
3 Mace/Pepper Spray Canister
4 Leash Thumb Buttons
5 Amber Nano Beam Light
6 Siren/Radio Speaker
7 9-Volt battery for Siren, Light Alarm (Rechargeable Flat Cell Phone-Type Battery—Lithium 3.7 Volt 850 or Higher)
8 Recharge Input Jack
9 Panic Button
10 Panic Lights
11 Optional Fiber-Optic Rope
Nano Beam Front Flashlight

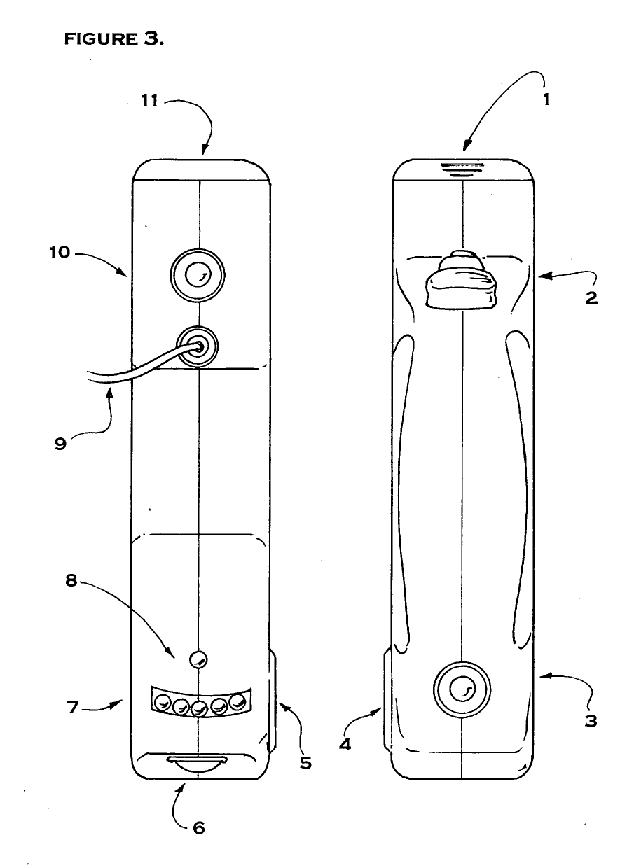

### Front and Rear Views FIG. 3

### Rear View

1 Pepper Spray Lid Thumb Release
2 Leash Control Buttons
3 Amber Nano Beam Light
4 Panic Siren

### Front View

5 Panic Siren
6 Panic Button
7 Twin Panic Lights—Yellow/Red/Green
8 Panic Alarm Circuit Board Inside
9 Leash/Lead or Fiber Optic Rope (Optional)
10 Nano Beam Flashlight
11 Pepper Spray Lid

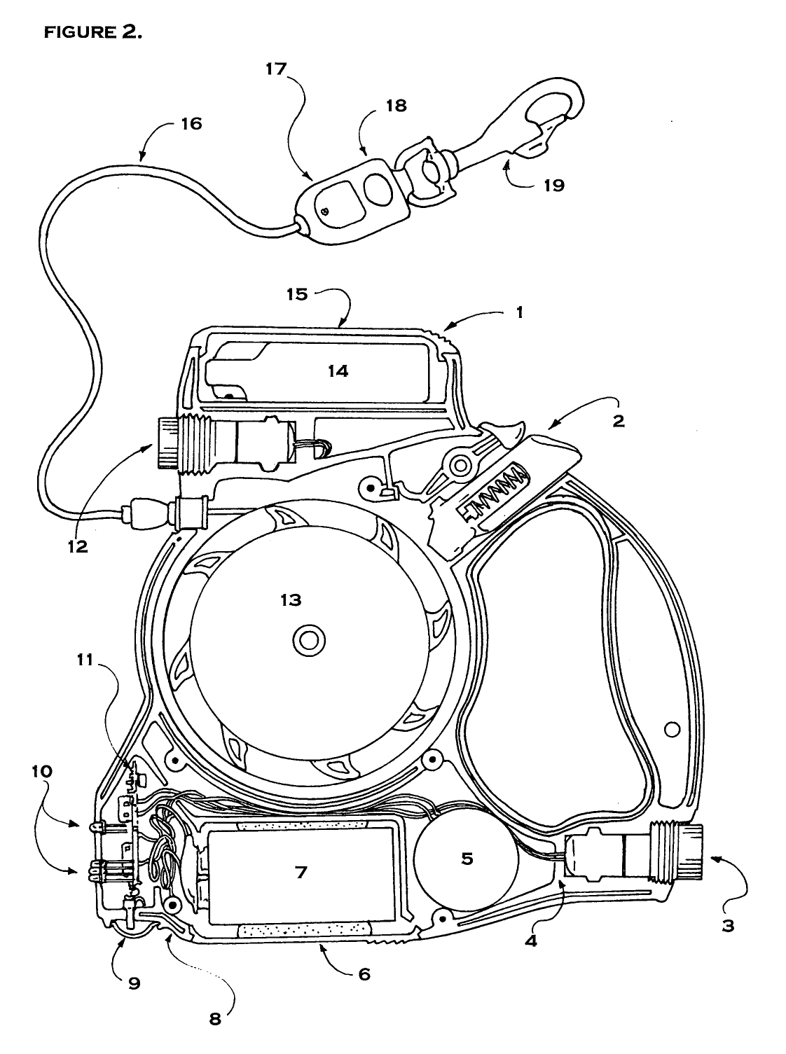

### Cutaway Side View FIG. 2

1 Thumb Release Latch
2 Leash Control Buttons
3 Amber Nano Beam Light Screw-In Detachable
4 Contact Option for Recharging
5 Panic Siren/Speaker
6 Battery Access Door
7 9-Volt Battery or Other Necessary Battery
8 Recharge Input Jack
9 Panic Button
10 Panic Lights
11 Circuit Board—Alarm and AM/FM
12 Screw-In Detachable Nano Beam Flashlight
13 16 Foot Rope
14 Pepper Spray
15 Pepper Spray Lid
16 Fiber Optic Rope
17 Battery Powered Fiber Optic Light Source
18 Light Switch Button
19 Clasp Hook for Dog Collar

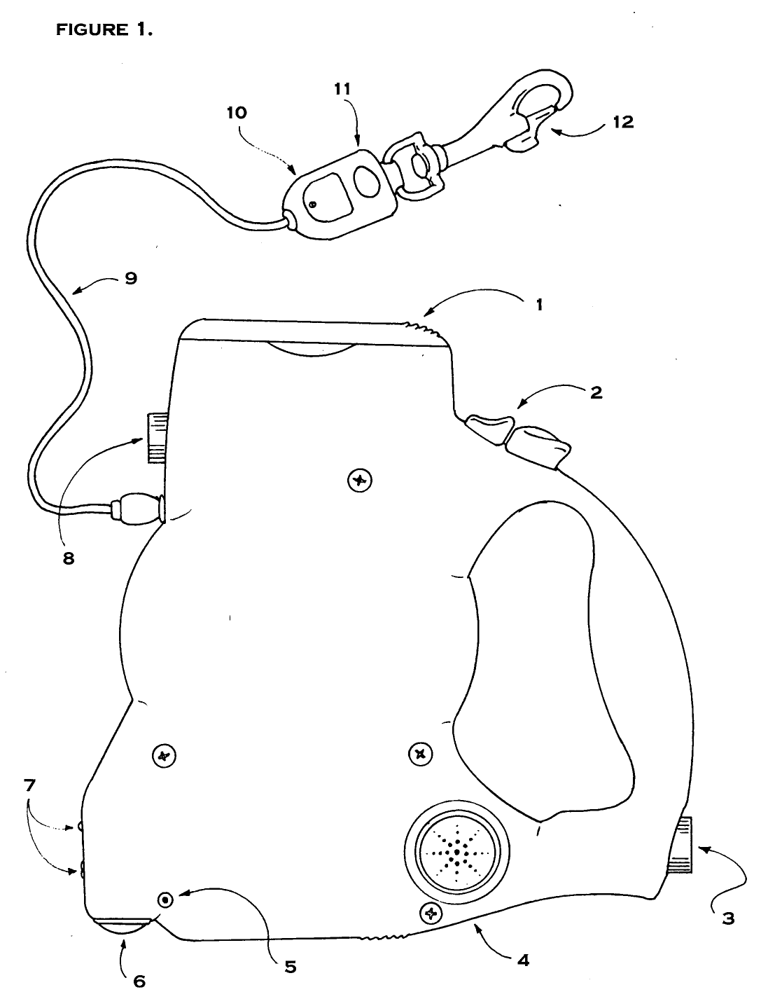

### Retractable Leash FIG. 1

1 Pepper Spray Holder
2 Leash Control Buttons
3 Amber Nano Beam Light Option for Different Lights.
4 Panic Siren and AM/FM Radio Speaker
5 Recharge Input Jack
6 Panic Button
7 Panic Lights
8 Nano Beam Flashlight
9 Fiber Optic Rope
10 Optional Fiber Optic Light Source—Battery Powered
11 Light Switch Button
12 Clasp Hook for Dog Collar

What is claimed is:

1. An illuminated/multi-faceted pet leash assembly, comprising of:
a) a leash;
b) a housing for containing said leash in a coiled state, said housing having a handle at one end and an opening for passage of said leash into said housing;
c) a spring loaded rotating reel contained within said housing for coiling said leash;
d) a stop mechanism for engaging said reel and for blocking rotation of said reel;
e) a button for activating said stop mechanism, said button positioned on said handle;
f) a light source integral to said housing;
g) a luminescent fiber optic filament in the leash material;
h) a rechargeable flash light component that is incorporated into the hand-held unit that is capable of being popped/pushed out of the unit and then can be retracted/inserted back into the unit for later use;
i) a pepper spray component that is incorporated into the hand-held unit that is capable of being popped/pushed out of the unit and then can be retracted/inserted back into the unit for later use;
j) an alarm horn component that is incorporated into the hand-held unit that is capable of being popped/pushed out of the unit and then can be retracted/inserted back into the unit for later use;
k) an electrical zapper/taser component that is incorporated into the hand-held unit and that is able to be popped/pushed out of the unit and then can be retracted/inserted back into the unit for later use; and
l) a power supply electrically coupled to said components (all components collectively referred to as the “Leash Assembly”).

2. The Leash Assembly of claim 1 in which said reel includes a plurality of teeth and said stop mechanism includes a portion for mating with said plurality of teeth.

3. The Leash Assembly of claim 1 having a spring loaded rotating reel contained within said housing for coiling said leash, said reel having a central axis and a plurality of teeth radially disposed about said central axis of said reel.

4. The Leash Assembly of claim 1 having a stop/lock mechanism for engaging said reel and for blocking rotation of said reel, said stop/lock mechanism having a teeth engaging member for complementary engagement of one of said plurality of teeth to stop rotation of said reel.

5. The Leash Assembly of claim 1 having a two position button for activating said stop/lock mechanism positioned proximate said handle, said button having a first position for advancing said teeth engaging member to engage one of said plurality of teeth and temporarily pause rotation of said reel as long as pressure is applied to said button by the user, and a second position for locking said teeth engaging member to engage one of said plurality of said teeth and stop rotation of said reel without application of pressure to said button by the user.

6. The Leash Assembly of claim 1 in which said button is spring biased.

7. The Leash Assembly of claim 1 further comprising a leash length limiter.

8. The Leash Assembly of claim 4 in which said leash length limiter includes a stop member for limiting the length of leash exiting said housing, said stop member being removably engaged to said leash.

9. The Leash Assembly of claim 4 in which said leash length limiter includes means for limiting the rotation of said reel within said housing.

10. The Leash Assembly of claim 6 in which said limiting means includes at least one groove in said reel, said groove having a stop, and an engaging member fitting within said groove for engaging said stop to limit the rotation of said reel.

11. The Leash Assembly of claim 1 in which said power supply is a rechargeable battery.

12. The Leash Assembly of claim 1 further comprising of several switches for activating said components.

13. The Leash Assembly of claim 11 in which said switches are positioned on said handle and can be activated by a user's thumb or other fingers.

14. The Leash Assembly of claim 12 in which said switches are oriented and located so as to allow activation with user's thumb or other fingers.

15. The Leash Assembly of claim 1 further comprising a luminescent fiber optic filament in the leash material reflecting/giving off light at night.

16. The Leash Assembly of claim 1 further comprising rechargeable flash light component that is incorporated into the hand-held unit that is capable of being popped/pushed out of the unit and then can be retracted/inserted back into the unit for later use.

17. The Leash Assembly of claim 1 further comprising a pepper spray component that is incorporated into the hand-held unit that is capable of being popped/pushed out of the unit and then can be retracted/inserted back into the unit for later use.

18. The Leash Assembly of claim 1 further comprising an alarm horn component that is incorporated into the hand-held unit that is capable of being popped/pushed out of the unit and then can be retracted/inserted back into the unit for later use.

19. (canceled)

20. The Leash Assembly of claim 1 further comprising a power supply electrically coupled to said components.

21. The Leash Assembly of claim 1 further comprising a wrist strap connected to said handle for engaging the wrist of the user.
